(19) United States
(12) Patent Application Publication
(10) Pub. No.: US 2018/0228212 A1
(43) Pub. Date: Aug. 16, 2018

(54) ELECTRONIC CIGARETTE TIP CLEANING DEVICE

(71) Applicant: Weston Kirbo, Brownwood, TX (US)

(72) Inventor: Weston Kirbo, Brownwood, TX (US)

(21) Appl. No.: 15/430,507

(22) Filed: Feb. 12, 2017

(51) Int. Cl. A24F 9/08; A24F 47/00; B08B 1/00; B08B 9/023

(52) U.S. Cl. CPC A24F 9/08; A24F 47/002; B08B 9/023; B08B 1/003; B08B 1/002

(57) ABSTRACT

An electronic cigarette tip cleaning device that provides users of electronic cigarettes with a product specifically designed for cleaning and sanitizing the tips of these e-cigarettes. The electronic cigarette tip cleaning device includes an indicia identifying the electronic cigarette tip cleaning device, a base tube having a generally tubular shape, a gripping surface placed on a side surface of the base tube to facilitate grasping the electronic cigarette tip cleaning device and a key chain hook having an aperture disposed on the key chain hook, the key chain hook extends from the side surface of the base tube to receive a key chain is inserted through the aperture and held within the aperture.

### BACKGROUND OF THE INVENTION

### Field of the Invention

The present invention is a cleaning device. More specifically, the present invention is an electronic cigarette tip cleaning device.

### Description of the Related Art

Many individuals who utilize e-cigarettes find accumulated dead skin cells and other debris on the tips of e-cigarettes to be unsightly and unsanitary.

Presently, there are no products available on the market capable of allowing users to efficiently clean and sanitize the tips of their e-cigarette. Ingenious, practical and useful, the electronic cigarette tip cleaning device is an innovative product which provides a simple and comprehensive solution to clearing away unpleasant build-up.

### SUMMARY OF THE INVENTION

The present invention is a cleaning device. More specifically, the present invention is an electronic cigarette tip cleaning device.

The electronic cigarette tip cleaning device includes an indicia identifying the electronic cigarette tip cleaning device, a base tube having a generally tubular shape, a gripping surface placed on a side surface of the base tube to facilitate grasping the electronic cigarette tip cleaning device and a key chain hook having an aperture disposed on the key chain hook, the key chain hook extends from the side surface of the base tube to receive a key chain is inserted through the aperture and held within the aperture.

It is an object of the present invention to provide an electronic cigarette tip cleaning device that provide users of electronic cigarettes with a product specifically designed for cleaning and sanitizing the tips of these e-cigarettes.

It is an object of the present invention to provide an electronic cigarette tip cleaning device that is designed specifically for cleaning e-cigarette tips, and its soft, flexible outer shell allows it to adapt to the shape and size of all e-cigarette tips.

It is an object of the present invention to provide an electronic cigarette tip cleaning device that includes a keychain hook providing safe and convenient storage when not in use.

It is an object of the present invention to provide an electronic cigarette tip cleaning device that is intended to be made readily available in a variety of colors to meet any consumer preference.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a first overhead view of an electronic cigarette tip cleaning device, in accordance with one embodiment of the present invention.

FIG. 2 illustrates a first side view of an electronic cigarette tip cleaning device, in accordance with one embodiment of the present invention.

FIG. 3 illustrates a first bottom view of an electronic cigarette tip cleaning device, in accordance with one embodiment of the present invention.

FIG. 4 illustrates a second bottom view of an electronic cigarette tip cleaning device, in accordance with one embodiment of the present invention.

FIG. 5 illustrates a second side view of an electronic cigarette tip cleaning device, in accordance with one embodiment of the present invention.

FIG. 6 illustrates a third bottom view of an electronic cigarette tip cleaning device, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

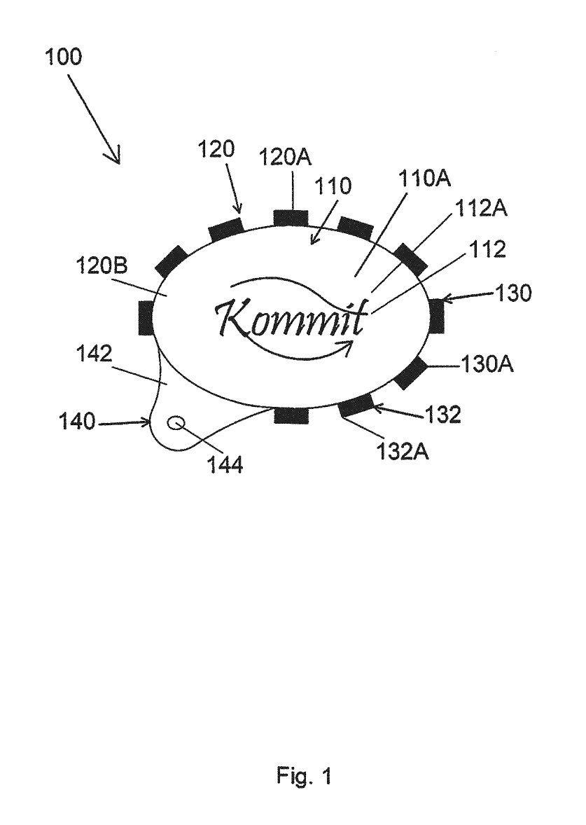

FIG. 1 illustrates a first overhead view of an electronic cigarette tip cleaning device 100, in accordance with one embodiment of the present invention.

The electronic cigarette tip cleaning device 100 may include an indicia 110, a base tube 120, a gripping surface 130 and a key chain hook 140.

The indicia 110 may be a functional indicia 110A such as a moniker 112 for the electronic cigarette tip cleaning device 100 to identify the electronic cigarette tip cleaning device 100. The moniker 112 illustrated in FIG. 1 is a Kommit logo 112A that represents the name for the electronic cigarette tip cleaning device 100. The base tube 120 may have a generally tubular shape 120A made of soft material. The base tube 120 may have a top 1208 where the indicia 110 may be placed. The gripping surface 130 may be placed on a side surface 130A of the base tube 120 adapted to facilitate grasping the electronic cigarette tip cleaning device 100. Specifically, the gripping surface 130 may have a plurality of raised gripping teeth 132 having a generally square-shape 132A or other suitable shape. The raised gripping teeth 132 may be equidistant to facilitate making the gripping surface 130. The key chain hook 140 may have a semi-circular planar shape 142 having an aperture 144 disposed on the semi-circular planar shape 142. The key chain hook 140 may extend from the side surface 140A of the base tube 120 adapted to receive a key chain (not shown) or another suitable object adapted to insert through the aperture 144 and adapted to hold within the aperture 144.

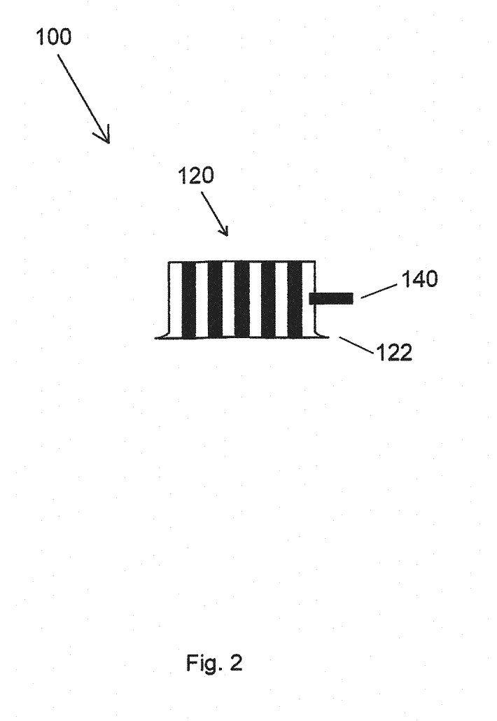

FIG. 2 illustrates a first side view of an electronic cigarette tip cleaning device 100, in accordance with one embodiment of the present invention.

The electronic cigarette tip cleaning device 100 may include the base tube 120 having a flanged bottom 122 adapted to facilitate grasping the electronic cigarette tip (not shown) after the electronic cigarette tip cleaning device 100 adapted to insert and remove from the electronic cigarette tip.

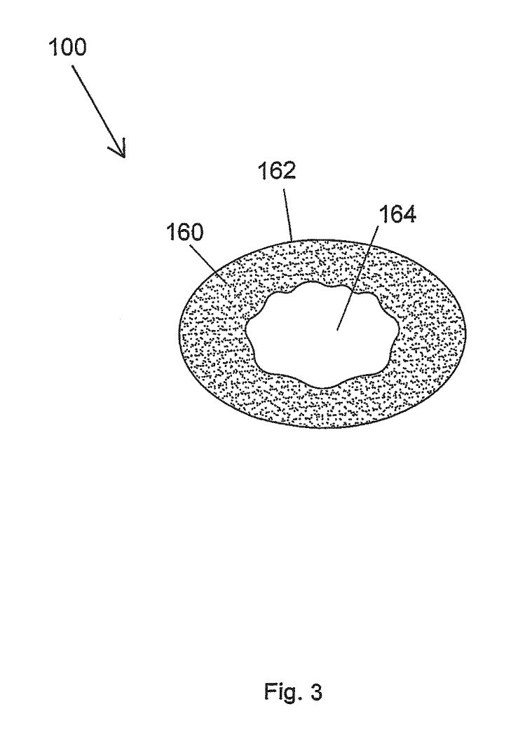

FIG. 3 illustrates a first bottom view of an electronic cigarette tip cleaning device 100, in accordance with one embodiment of the present invention.

The electronic cigarette tip cleaning device 100 may include a sponge 160 extending from an interior surfacing 162 of the electronic cigarette tip cleaning device 100. The sponge 160 may extend from the entire interior surfacing 162 or any portion thereof the interior surfacing 162. The sponge 160 may form an opening 164 adapted to receive an inserted electronic cigarette tip (not shown). The sponge 160 may contact the inserted electronic cigarette tip and adapted to clean the inserted electronic cigarette tip as the inserted electronic cigarette tip is adapted to inserted back and forth inside of the electronic cigarette tip cleaning device 100 or adapted to enter either end of the electronic cigarette tip cleaning device 100 and then adapted to rotate for an effective cleaning action, with alcohol adapted to add to the electronic cigarette tip cleaning device 100 to provide a sterilizing function. The sponge 160 may have a wavy contact surface adapted to facilitate cleaning the inserted electronic cigarette tip. The sponge 160 may be made of material selected from the group consisting of cellulose wood fibers, foamed plastic polymers, natural sponge, low-density polyether, polyvinyl acetate or PVA or polyester.

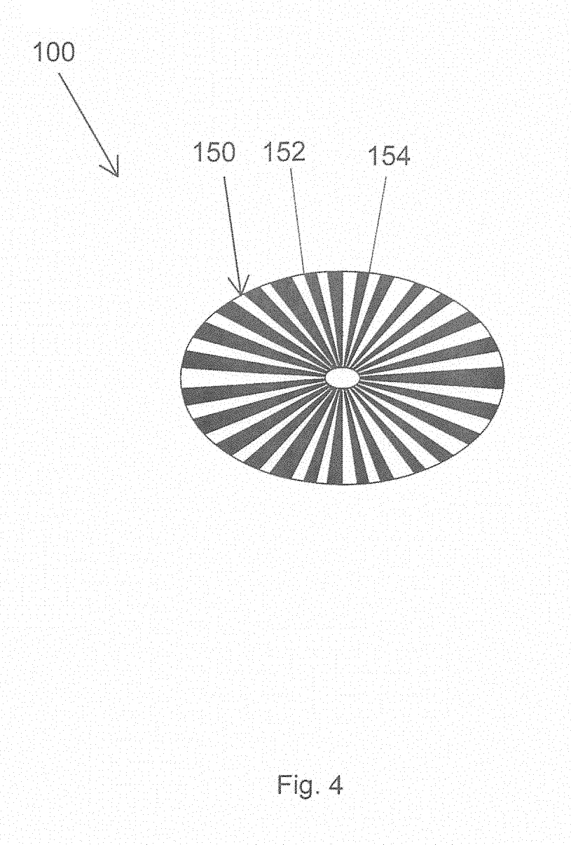

FIG. 4 illustrates a second bottom view of an electronic cigarette tip cleaning device 100, in accordance with one embodiment of the present invention.

The electronic cigarette tip cleaning device 100 may include a plurality of bristles 150. The bristles 150 may adapted to clean an inserted electronic cigarette tip (not shown) as the electronic cigarette tip is adapted to insert back and forth inside of the electronic cigarette tip cleaning device 100 or adapted to enter either end of the electronic cigarette tip cleaning device 100 and then adapted to rotate for an effective cleaning action, with alcohol adapted to add to the electronic cigarette tip cleaning device 100 to provide a sterilizing function. The bristles 150 may be equidistant and form a circle 152 at each of the bristle ends 154 adapted to facilitate contact with the inserted electronic cigarette tip. The bristles 150 may be made of material selected from the group consisting of animal hair, vegetable fiber or synthetic fiber.

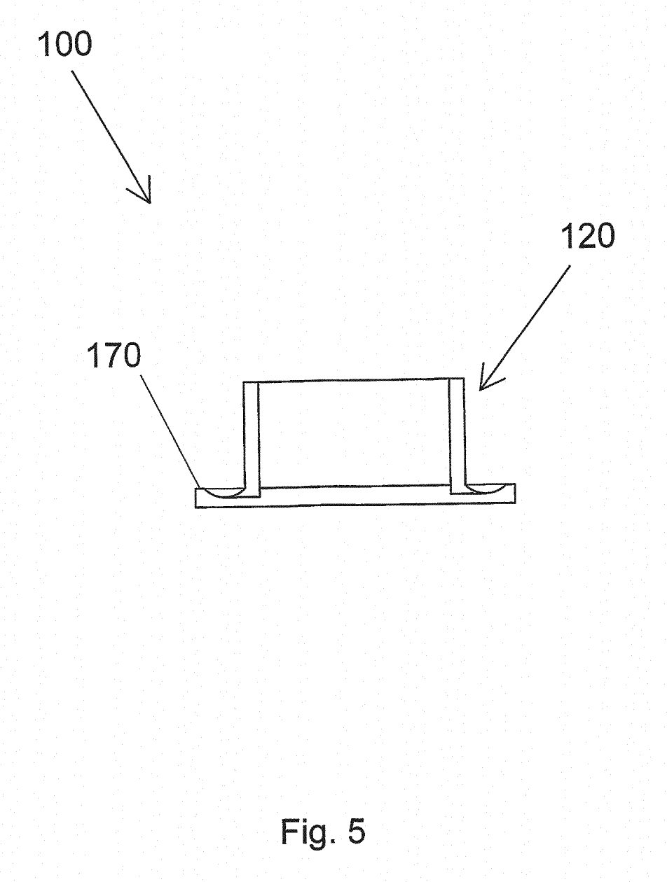

FIG. 5 illustrates a second side view of an electronic cigarette tip cleaning device 100, in accordance with one embodiment of the present invention.

The electronic cigarette tip cleaning device 100 may include a transparent cap 170. The transparent cap 170 may be airtight to prevent any loss of rubbing alcohol that may be adapted to clean the electronic cigarette tip cleaning device 100 or the inserted electronic cigarette tip (not shown). The transparent cap 170 may be made of material selected from the group consisting of transparent rubber, transparent poly (methyl methacrylate) or PMMA or PLEXIGLASS®, transparent heat resistant glass or PYREX® or transparent glass.

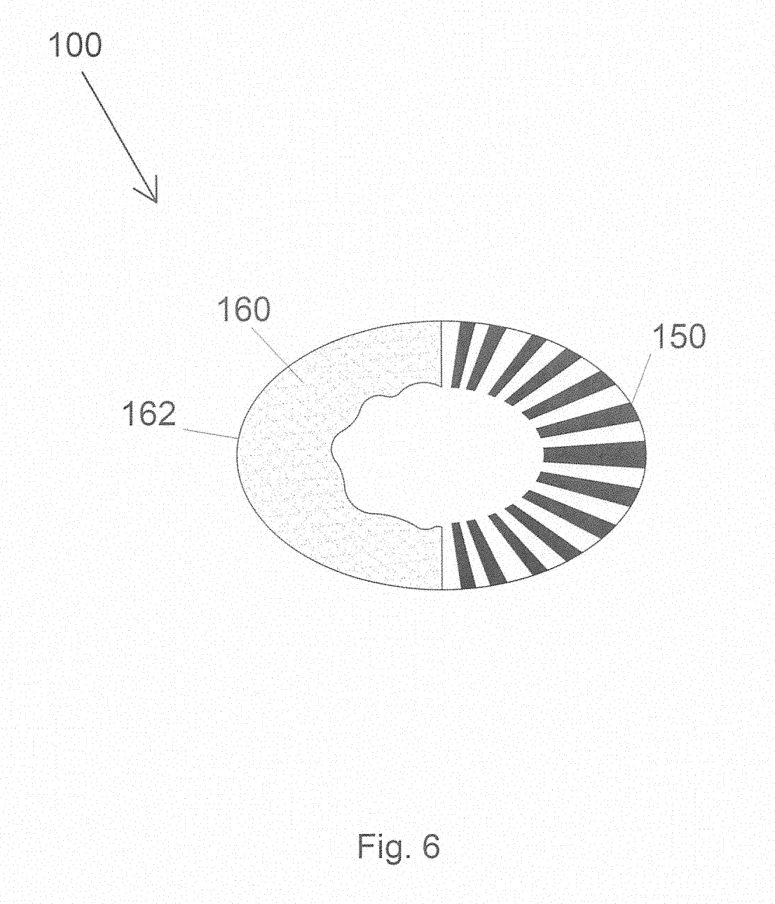

FIG. 6 illustrates a third bottom view of an electronic cigarette tip cleaning device 100, in accordance with one embodiment of the present invention.

The electronic cigarette tip cleaning device 100 may include a sponge (FIG. 4, 160) extending from approximately half of the interior surfacing 162 of the electronic cigarette tip cleaning device 100 and a plurality of bristles (FIG. 3, 150) extending from approximately the other half of the interior surfacing 162 of the electronic cigarette tip cleaning device 100. The bristles 150 may be equidistant and have the same length and be adapted to position directly across from the sponge 160 adapted to facilitate contact with the inserted electronic cigarette tip and adapted to facilitate cleaning the inserted electronic cigarette tip. The sponge 160 may be made of material selected from the group consisting of cellulose wood fibers, foamed plastic polymers, natural sponge, low-density polyether, polyvinyl acetate or PVA or polyester. The bristles 150 may be made of material selected from the group consisting of animal hair, vegetable fiber or synthetic fiber.

Use of the electronic cigarette tip cleaning device 100 is straightforward. An electronic cigarette tip (not shown) may be adapted to insert into the electronic cigarette tip cleaning device 100 and is adapted to inserted back and forth inside of the electronic cigarette tip cleaning device 100 to clean the electronic cigarette tip with the bristles 150 or the sponge 160 extending from an interior surfacing 162 of the electronic cigarette tip cleaning device 100. The electronic cigarette tip cleaning device 100 may include a flanged bottom 142 to facilitate grasping the electronic cigarette tip after the electronic cigarette tip cleaning device 100 is inserted and removed from the electronic cigarette tip and a gripping surface 130 may be placed on a side surface 130A of the electronic cigarette tip cleaning device 100 adapted to facilitate grasping the electronic cigarette tip cleaning device 100. The e-cigarette tip may adapted to enter on either end of the electronic cigarette tip cleaning device 100 and then adapted to rotate for an effective cleaning action, with the alcohol component also providing a sterilizing function. The electronic cigarette tip cleaning device 100 may prove to be an essential accessory for the a-cigarette user and may be readily available at smoke shops, gas stations, retail department stores, and online retailers.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

What is claimed is:

1. An electronic cigarette tip cleaning device, comprising:
an indicia identifying the electronic cigarette tip cleaning device;
a base tube having a generally tubular shape, the base tube has a top where the indicia is placed;
a gripping surface placed on a side surface of the base tube adapted to facilitate grasping the electronic cigarette tip cleaning device; and
a key chain hook having an aperture disposed on the key chain hook, the key chain hook extends from the side surface of the base tube adapted to receive a key chain adapted to insert through the aperture and adapted to hold within the aperture.

2. The electronic cigarette tip cleaning device according to claim 1, further comprising a plurality of bristles adapted to clean an inserted electronic cigarette tip.

3. The electronic cigarette tip cleaning device according to claim 2, wherein the bristles are adapted to clean an inserted electronic cigarette tip as the electronic cigarette tip is adapted to be inserted back and forth inside of the electronic cigarette tip cleaning device.

4. The electronic cigarette tip cleaning device according to claim 2, wherein either end of the electronic cigarette tip is adapted to be entered into the electronic cigarette tip cleaning device and then adapted to be rotated for a cleaning action.

5. The electronic cigarette tip cleaning device according to claim 4, wherein alcohol is added to the electronic cigarette tip cleaning device to provide a sterilizing function.

6. The electronic cigarette tip cleaning device according to claim 2, wherein the bristles are equidistant and form a circle at each of the bristle ends adapted to facilitate contact with the inserted electronic cigarette tip.

7. The electronic cigarette tip cleaning device according to claim 2, wherein the made of material selected from the group consisting of animal hair, vegetable fiber or synthetic fiber.

8. The electronic cigarette tip cleaning device according to claim 1, further comprising a sponge extending from an interior surfacing of the electronic cigarette tip cleaning device.

9. The electronic cigarette tip cleaning device according to claim 8, wherein the sponge extends from the entire interior surfacing or any portion thereof the interior surfacing.

10. The electronic cigarette tip cleaning device according to claim 8, wherein the sponge forms an opening adapted to receive an inserted electronic cigarette tip.

11. The electronic cigarette tip cleaning device according to claim 8, wherein the sponge cleans an inserted electronic cigarette tip as the electronic cigarette tip adapted to insert back and forth inside of the electronic cigarette tip cleaning device.

12. The electronic cigarette tip cleaning device according to claim 8, wherein either end of the electronic cigarette tip adapted to enter into the electronic cigarette tip cleaning device and then adapted to rotate for a cleaning action.

13. The electronic cigarette tip cleaning device according to claim 12, wherein alcohol adapted to add to the electronic cigarette tip cleaning device to provide a sterilizing function.

14. The electronic cigarette tip cleaning device according to claim 8, wherein the sponge has a wavy contact surface to facilitate contact with the inserted electronic cigarette tip.

15. The electronic cigarette tip cleaning device according to claim 8, wherein the sponge is made of material selected from the group consisting of cellulose wood fibers, foamed plastic polymers, natural sponge, low-density polyether, polyvinyl acetate or PVA or polyester.

16. The electronic cigarette tip cleaning device according to claim 1, wherein the indicia is a functional indicia moniker for the electronic cigarette tip cleaning device.

17. The electronic cigarette tip cleaning device according to claim 1, wherein the base tube has a flanged bottom adapted to facilitate grasping the electronic cigarette tip.

18. The electronic cigarette tip cleaning device according to claim 1, wherein the electronic cigarette tip cleaning device includes an airtight transparent cap to prevent any loss of rubbing alcohol adapted to clean the electronic cigarette tip.

19. The electronic cigarette tip cleaning device according to claim 18, wherein the airtight transparent cap is made of material selected from the group consisting of transparent rubber, transparent poly (methyl methacrylate), transparent heat resistant glass or transparent glass.

20. The electronic cigarette tip cleaning device according to claim 1, wherein the electronic cigarette tip cleaning device includes the sponge extending from half of the interior surfacing of the electronic cigarette tip cleaning device and the bristles extending from the other half of the interior surfacing of the electronic cigarette tip cleaning device.
